(19) United States
(12) Patent Application Publication
(10) Pub. No.: US 2006/0205364 A1
(43) Pub. Date: Sep. 14, 2006

(54) MULTIFUNCTIONAL PORTABLE ELECTRONIC DEVICE

(76) Inventor: Ga-Lane Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,539

(22) Filed: Feb. 13, 2006

(30) Foreign Application Priority Data
Mar. 11, 2005 (CN) 200510033622.5

(51) Int. Cl. H04B 1/38

(52) U.S. Cl. 455/90.3

(57) ABSTRACT

This invention relates to a multifunctional portable electronic device including a main body and a clasp. The main body houses a printed circuit board, and a power supply module for supplying power to the printed circuit board, the printed circuit board having a radio frequency module mounted thereon for providing a wireless communication function. The clasp is coupled to the main body for clasping a wrist of a user.

### FIELD OF THE INVENTION

This invention relates to portable electronic device, and more particularly, to a multifunctional portable electronic device.

### DESCRIPTION OF RELATED ART

With the development of wireless communication technology and information processing technology, multifunctional portable personal communication devices, such as mobile phones with cameras, are very popular in recent years, since these devices provide users with not only voice communication, but also photographic functions.

However, the conventional mobile phones are generally pocketed by the users. Therefore, the users may fail to find incoming calls or messages right away when the mobile phones are set in vibration modes or the users are situated in a noisy environment. In addition, the conventional mobile phone is generally pocketed instead of being fastened to the body of the user. Thus, the mobile phone is easy to get lost.

What is needed, therefore, is to provide an improved multifunctional portable electronic device.

### SUMMARY OF INVENTION

A preferred embodiment provides a multifunctional portable electronic device including a main body and a clasp. The main body houses a printed circuit board, and a power supply module for supplying power to the printed circuit board, the printed circuit board having a radio frequency module mounted thereon for providing a wireless communication function. The clasp is coupled to the main body for clasping a wrist of a user.

Compared with the conventional mobile phones, the multifunctional portable electronic device according to the preferred embodiment is equipped with a clasp, which makes the multifunctional portable electronic device be prevented from lost by way of holding the multifunctional portable electronic device on a user's wrist. In addition, because the wrist is a sensitive part of the user, therefore the user can find incoming calls or messages right away.

Other advantages and novel features will become more apparent from the following detailed description of embodiments when taken in conjunction with the accompanying drawings.

### BRIEF DESCRIPTION OF DRAWINGS

Many aspects of the multifunctional portable electronic device can be better understood with reference to the following drawings. The components in the drawings are not necessarily to scale, the emphasis instead being placed upon clearly illustrating the principles of the present multifunctional portable electronic device. Moreover, in the drawings, like reference numerals designate corresponding parts throughout the several views.

FIG. 1 is a schematic, isometric view of a multifunctional portable electronic device in accordance with a preferred embodiment of present invention.

FIG. 2 is similar to FIG. 1, but viewed from another aspect.

The exemplifications set out herein illustrate at least one preferred embodiment of the multifunctional portable electronic device, in one form, and such exemplifications are not to be construed as limiting the scope of the invention in any manner.

### DETAILED DESCRIPTION

Reference will now be made to the drawing figures to describe the present invention in detail.

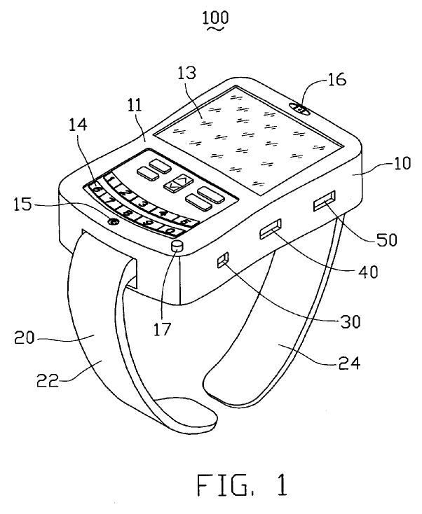

Referring to FIG. 1, a multifunctional portable electronic device 100 according to a preferred embodiment is shown. The multifunctional portable electronic device 100 includes a main body 10 and a clasp 20. The main body 10 can be secured to a user's wrist via the clasp 20. Preferably, the main body 10 and clasp 20 each have a surface formed with a photocatalytic layer (not shown) made of nano-particles. The nano-particles may be titanium oxide (TiO2), silver (Ag), or zinc oxide (ZnO2), etc. The photocatalytic layer has antibacterial and self-cleaning functions. A thickness of the photocatalytic layer is in a range from 10 to 1000 nanometers. Advantageously, the thickness is in a range from 20 to 500 nanometers.

Generally, the clasp 20 may be configured similar to a conventional watchband. In the illustrated embodiment, the clasp 20 includes a first band portion 22, a spatially opposite second band portion 24, and an adjustable fastening means such as a buckle (not shown) for connecting and fastening distal ends of the first band portion 22 and the second band portion 24 together. The first band portion 22 and the second band portion 24 are connected with two opposite sides of the main body 10 respectively. The clasp 20 may be made of metal, leather, cloth, plastic, etc. Preferably, the clasp 20 is removable from the main body 10.

The main body 10 includes a printed circuit board and a power supply module. The printed circuit board and the power supply module are housed in the main body 10. The printed circuit board includes a radio frequency module mounted thereon for providing a wireless communication function compatible with a conventional mobile phone. Advantageously, the printed circuit board is flexible. The main body 10 includes a display screen 13 and a keyboard unit 14 arranged on a front surface 11 thereof.

The display screen 13 may be an E-paper display screen, such as electrophoretic display screen, or an organic light-emitting diode display screen, etc. Alternatively, the display screen 13 may be a transflective display screen. The display screen 13 is electrically connected to the printed circuit board and the power supply module. Generally, the display screen 13 can be used to display time, messages, images, etc.

The keyboard unit 14 is arranged adjacent the display screen 13, and can be a flexional woolen keyboard. The keyboard unit 14 includes a plurality of key buttons, and the key buttons can be configured similar to that of a conventional mobile phone. The keyboard unit 14 is electrically connected to the printed circuit board and the power supply module.

An optical disc player module 30 can be configured in the main body 10, and is electrically connected to the printed circuit board and the power supply module. The optical disc player module 30 may have an operation wavelength in the range from 650 to 780 nanometers, and can receive compact disc, digital video disc, etc. therein.

A microphone 15 and a speaker 16 are arranged on a front surface 11 of the main body 10. The microphone 15 and the speaker 16 are spaced apart from each other and located at opposite sides of the display screen 13 and the keyboard unit 14. The relative position of the microphone 15 and the speaker 16 is configured to ensure the ergonomics. The microphone 15 and the speaker 16 are electrically connected to the printed circuit board and the power supply module. Advantageously, an emergency switch 17 is formed on the front surface 11 of the main body 10; in case of the user encountering an accident or emergency, the emergency switch 17 can be triggered and send a rescue signal to a nursing department, such as 911, etc.

Further, a micro-drive 40 is housed in the main body 10, and electrically connected to the printed circuit board and the power supply module. The micro-drive 40 has a storage capacity in a range from 2 to 200 Gigabytes, and can be a 1-inch micro-drive.

In addition, a MP3 player module 50 is configured inside the main body 10. The MP3 player module 50 is integrated with the printed circuit board for providing an MP3 function. Generally, the MP3 player module 50 includes a solid-state memory, such as a flash memory which does not occupy too much space.

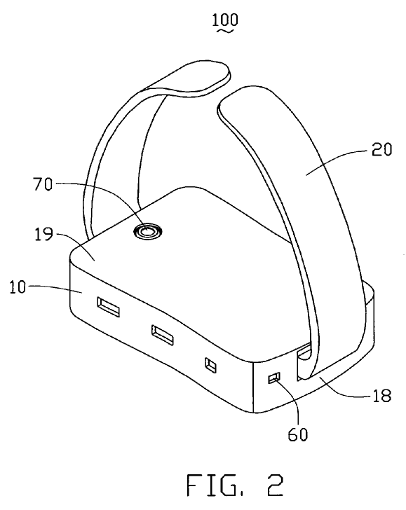

Referring to FIG. 2, an Infrared Data Association (hereinafter, IrDA) interface 60 is formed on a top side 18 of the main body 10. The IrDA interface 60 is electrically connected with the printed circuit board and the power supply module for exchange datum with the other electronic devices, such as mobile phones, personal computers, etc.

In addition, a camera module 70 is configured in the main body 10, with a lens (not labeled) thereof exposed to an outside of the rear surface 19 of the main body 10. The lens can be an aspheric lens. The camera module 70 further includes a zoom mechanism. The zoom mechanism can be driven by a motor selected from the group consisting of a piezoelectric motor, a voice coil motor, and a stepping motor. The camera module 70 is electrically connected to the printed circuit board and the power supply module in the main body 1. The camera module 70 serves as a digital camera.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multifunctional portable electronic device, comprising:
a main body housing a printed circuit board, and a power supply module for supplying power to the printed circuit board, the printed circuit board having a radio frequency module mounted thereon for providing a wireless communication function; and
a clasp coupled to the main body configured for clasping a wrist of a user.

2. The multifunctional portable electronic device of claim 1, wherein the clasp is made of a material selected from the group consisting of metal, leather, cloth and plastic.

3. The multifunctional portable electronic device of claim 1, wherein the clasp comprises a first band portion, a spatially opposite second band portion, and a buckle for fastening the first band portion and the second band portion together; the first band portion and the second band portion being connected with two opposite ends of the main body respectively.

4. The multifunctional portable electronic device of claim 1, wherein the main body comprises an optical disc player module electrically connected to the printed circuit board and the power supply module.

5. The multifunctional portable electronic device of claim 1, wherein the main body has a surface formed with a photocatalytic layer comprised of nano-particles, the nano-particles being comprised of a material selected from the group consisting of titanium oxide, silver, and zinc oxide.

6. The multifunctional portable electronic device of claim 5, wherein the clasp has a surface formed with a photocatalytic layer comprised of nano-particles, the nano-particles being comprised of a material selected from the group consisting of titanium oxide, silver, and zinc oxide.

7. The multifunctional portable electronic device of claim 1, wherein a micro-drive is configured inside the main body, the micro-drive being electrically connected to the printed circuit board and the power supply module.

8. The multifunctional portable electronic device of claim 1, further comprising an MP3 player module, the MP3 player module is integrated with the printed circuit board.

9. The multifunctional portable electronic device of claim 1, further comprising a camera module configured in the main body, the camera module being electrically connected with the printed circuit board and the power supply module.

10. The multifunctional portable electronic device of claim 9, wherein the camera module comprises a zoom mechanism, the zoom mechanism being driven by a motor selected from the group consisting of a piezoelectric motor, a voice coil motor, and a stepping motor.

11. The multifunctional portable electronic device of claim 1, further comprising an infrared data association interface, the infrared data association interface being arranged on a lateral side of the main body, and electrically connected to the printed circuit board and the power supply module.

12. The multifunctional portable electronic device of claim 1, further comprising an emergency switch arranged on the main body.

13. The multifunctional portable electronic device of claim 1, further comprising a display screen configured on the main body; the display screen being selected from the group consisting of an electrophoretic display screen, an organic light-emitting diode display screen, and a transflective display screen.

14. The multifunctional portable electronic device of claim 1, further comprising a woolen keyboard unit having a plurality of key buttons configured on the main body.

15. The multifunctional portable electronic device of claim 1, wherein the print circuit board is a flexible printed circuit board.
